(19) United States
(12) Patent Application Publication
(10) Pub. No.: US 2025/0317999 A1
(43) Pub. Date: Oct. 9, 2025

(54) COEXISTENCE MANAGEMENT IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Bilal Sadiq, Plano, TX (US)

(21) Appl. No.: 19/087,905

(22) Filed: Mar. 24, 2025

Related U.S. Application Data
(60) Provisional application No. 63/573,978, filed on Apr. 3, 2024.
(60) Provisional application No. 63/575,448, filed on Apr. 5, 2024.

(51) Int. Cl. H04W 76/14; H04W 52/02; H04W 72/0446

(52) U.S. Cl. CPC H04W 76/14; H04W 52/0258; H04W 72/0446

(57) ABSTRACT

A station (STA) in a wireless network. The STA has a memory; and a processor coupled to the memory. The STA transmits, to an access point (AP), a frame indicating an upcoming coexistence event schedule. The STA performs peer-to-peer communication with one or more peer STAs during the upcoming coexistence event schedule.

### CROSS REFERENCE TO RELATED APPLICATION(S)

This application claims benefit of U.S. Provisional Application No. 63/573,978, entitled “COEXISTENCE MANAGEMENT IN WLAN,” filed on Apr. 3, 2024; and U.S. Provisional Application No. 63/575,448, entitled “COEXISTENCE MECHANISMS FOR PEER-TO-PEER COMMUNICATIONS,” filed on Apr. 5, 2024, all of which are incorporated herein by reference in their entirety.

### TECHNICAL FIELD

This disclosure relates generally to a wireless communication system, and more particularly to, for example, but not limited to, peer-to-peer communication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol of a station (STA) informing an access point (AP) about a co-existence event for next generation WLAN devices.

An aspect of this disclosure provides an STA in a wireless network. The STA comprises a memory and a processor coupled to the memory. The processor is configured to cause transmitting, to an AP, a frame indicating an upcoming coexistence event schedule. The processor is further configured to cause performing peer-to-peer communication with one or more peer STAs during the upcoming coexistence event schedule.

In an embodiment, the frame indicates that the STA is unavailable for communication with the AP during the upcoming coexistence event schedule.

In an embodiment, the processor is further configured to cause performing communication with the AP after transmitting the frame, wherein the communication with the AP ends before a start of the upcoming coexistence event schedule.

In an embodiment, the frame includes a target wake time (TWT) element indicating one or more TWT service periods.

In an embodiment, the frame includes information indicating a duration for which the upcoming coexistence schedule remains valid.

In an embodiment, the frame includes information associated with the one or more peer STAs.

In an embodiment, the frame indicates information associated with identities, characteristics, or capabilities of the one or more peer STAs.

In an embodiment, the processor is further configured to cause receiving, from the AP, a control frame indicating a transmission opportunity (TXOP) duration. The processor is further configured to cause transmitting the frame in response to the control frame, wherein the frame indicates a period of time associated with the upcoming coexistence event schedule during which the STA is unavailable.

An aspect of the disclosure provides an AP in a wireless network. The AP comprises a memory and a processor coupled to the memory. The processor is configured to cause receiving, from an STA, a frame indicating an upcoming coexistence event schedule. The processor is further configured to cause abstaining from performing communication with the STA during the upcoming coexistence event schedule.

In an embodiment, the frame indicates that the STA is unavailable for communication with the AP during the upcoming coexistence event schedule.

In an embodiment, the processor is further configured to cause performing communication with the STA after receiving the frame. The processor is further configured to cause terminating the communication with the STA before a start of the upcoming coexistence event schedule.

In an embodiment, the frame includes a TWT element indicating one or more TWT service periods.

In an embodiment, the frame includes information indicating a duration of the upcoming coexistence schedule remains valid.

In an embodiment, the frame includes information associated with one or more peer STAs, wherein the one or more peer STAs perform communications with the STA during the upcoming coexistence schedule. The processor is further configured to cause abstaining from performing communication with the one or more peer STAs during the upcoming coexistence event schedule.

In an embodiment, the frame indicates information associated with identities, characteristics, or capabilities of the one or more peer STAs.

In an embodiment, the processor is further configured to cause transmitting, to the STA, a control frame indicating a TXOP duration. The processor is further configured to cause receiving the frame in response to the control frame, wherein the frame indicates a period of time associated with the upcoming coexistence event schedule during which the STA is unavailable.

An aspect of the disclosure provides a method performed by an STA. The method comprises transmitting, to an AP, a frame indicating an upcoming coexistence event schedule. The method further comprises performing peer-to-peer communication with one or more peer STAs during the upcoming coexistence event schedule.

In an embodiment, the frame indicates that the STA is unavailable for communication with the AP during the upcoming coexistence event schedule.

In an embodiment, the method further comprises performing communication with the AP after transmitting the frame. The communication with the AP ends before the start of the upcoming coexistence event schedule.

In an embodiment, the frame includes a TWT element indicating one or more TWT service periods.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example indication of a coexistence event in accordance with an embodiment.

FIG. 6 shows another example indication of a coexistence event in accordance with an embodiment.

FIG. 7 shows another example indication of a coexistence event in accordance with an embodiment.

FIG. 8 shows an example management of a coexistence event in accordance with an embodiment.

FIG. 9 shows an example management of a coexistence event in accordance with an embodiment.

FIG. 10 shows an example process of managing a coexistence event in accordance with an embodiment.

FIG. 11 shows an example process of managing a coexistence event in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

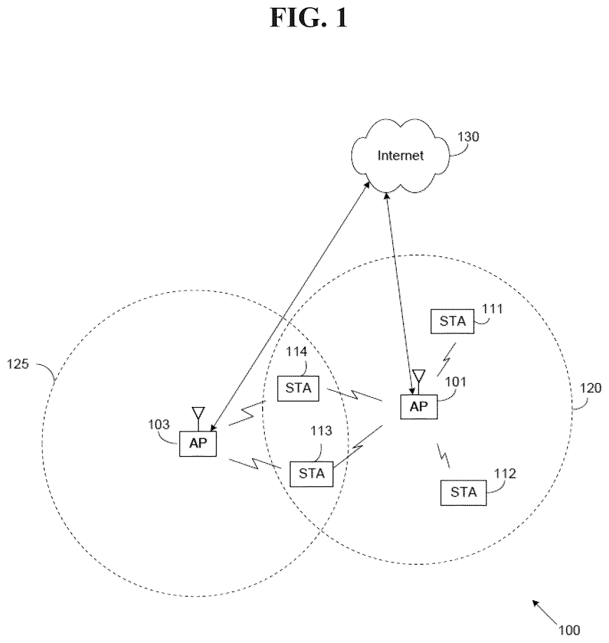

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

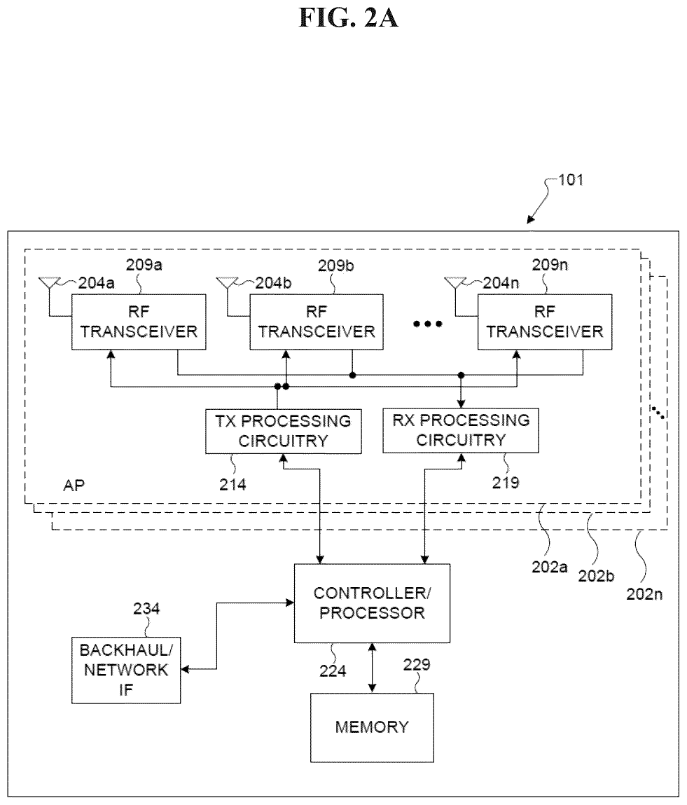

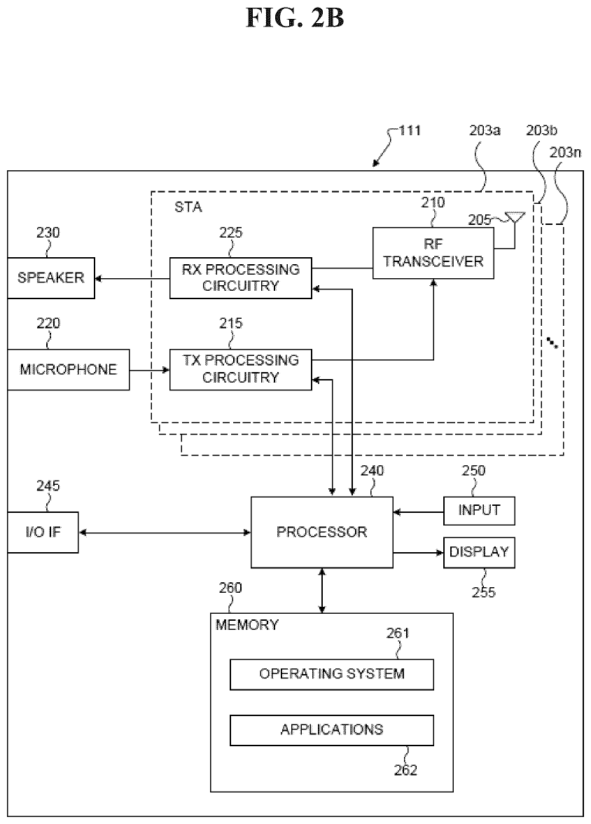

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

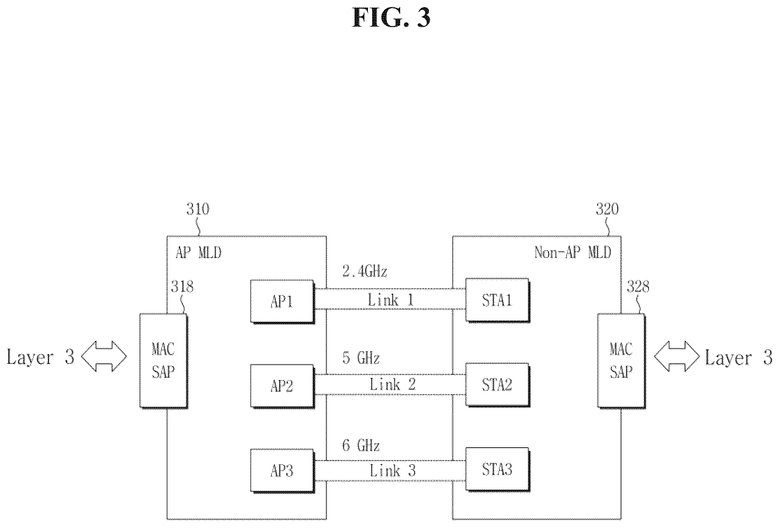

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

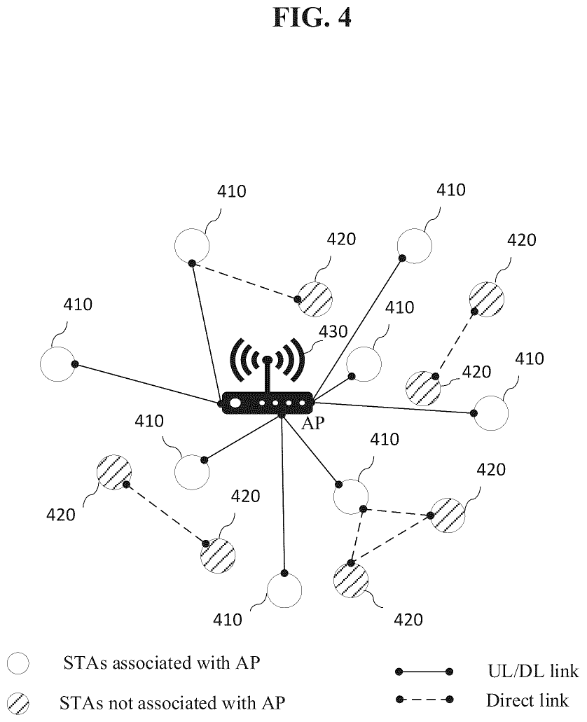

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network as shown in FIG. 4. Many of these devices may have a tolerance for latency, but still compete with the devices running low-latency applications for the same time and frequency resources. In some cases, the AP 430 as a network controller may not have enough control over the unregulated or unmanaged traffic that contends with the low-latency traffic within the infrastructure basic service set (BSS). In some embodiments, the infrastructure BSS is a basic service set that includes an AP 430 and one or more non-AP STAs 410, while the independent BSS is a basic service set where non-AP STAs 420 communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

A STA may be subject to coexistence event when in communication with an associated AP. A coexistence event is an event where the STA may be busy with transmitting to or receiving from another STA. Often, the coexistence event is related to peer-to-peer (P2P) communication with a peer STA. The result of a coexistence event is that the STA is busy and therefore is not available for communication with the associated AP. This creates a need for the STA communicating this non-availability to the associated AP. However, there is currently no mechanism for a STA to inform the AP about a coexistence event between two P2P STAs.

This disclosure provides a mechanism for a STA to inform an AP about the coexistence event between two P2P STAs, which may be referred to as Proxy Co-ex Indication (PCI) procedure. In an embodiment, a first STA can transmit a frame including an indication to an associated AP. The indication informs the AP about an upcoming coexistence event including the first STA. The coexistence event can occur between the first STA and a second STA. The second STA can be a peer STA of the first STA.

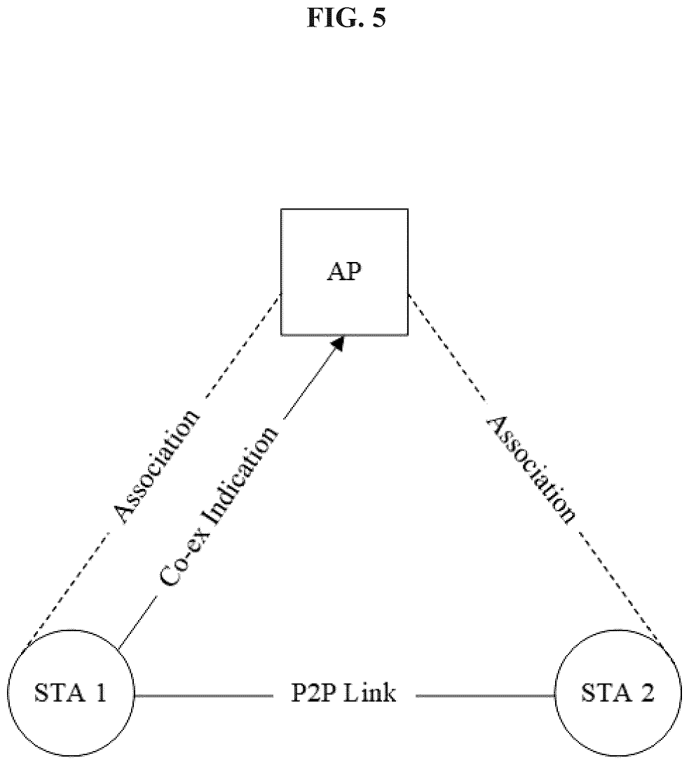

FIG. 5 shows an example indication of a coexistence event in accordance with an embodiment. The example depicted in FIG. 5 is for explanatory and illustration purposes. FIG. 5 does not limit the scope of this disclosure to any particular implementation.

Referring to FIG. 5, AP is associated with STA 1 and STA 2. STA 1 and STA 2 have a P2P link. STA 1 has a P2P communication with STA 2 as peer STAs, a coexistence event. STA 1 transmits, to AP, a frame including a coexistence indication (Co-ex indication). The coexistence indication informs AP of the upcoming coexistence event so that AP knows that STA 1 and STA 2 are busy.

In an embodiment, an AP may assume that a STA may not be available for communication with the AP for a period of time after the AP receives a frame from the STA indicating that the STA has an upcoming coexistence event involving the STA for the period of time. In an embodiment, an AP may not transmit any frame to a STA from which the AP has received a frame indicating a coexistence event involving the STA for a period of time until the period of time expires. In an embodiment, the AP may not expect to receive any frame from a STA from which the AP has received a frame indicating a coexistence event involving the STA for a period of time until the period of time expires.

In an embodiment, a STA can transmit, to an associated AP, a frame as a TXOP holder to indicate a coexistence event. The frame may include an indication of the period of time for which the STA may not be available for communication with the AP. In an embodiment, the frame may be a control frame or management frame.

In an embodiment, a STA can transmit, to an associated AP, a first frame as a TXOP responder to indicate an upcoming coexistence event. The first frame may include information associated the coexistence event, such as the duration of the coexistence event or other parameters related to the coexistence event. The AP may transmit a second frame before receiving the first frame indicating an initial TXOP. The second frame may be a request-to-send (RTS). The first frame may be a clear-to-send (CTS).

In an embodiment, a first STA can indicate to an AP information associated with an upcoming coexistence event that the first STA has with a second STA, a peer STA of the first STA. The information associated with the coexistence event may include information about the second STA, such as identifying information of the second STA or other characteristics and capabilities of the second STA. In an embodiment, the first STA and the second STA may be associated with the AP. In an embodiment, the first STA may be associated with the AP and the second STA may not be associated with the AP.

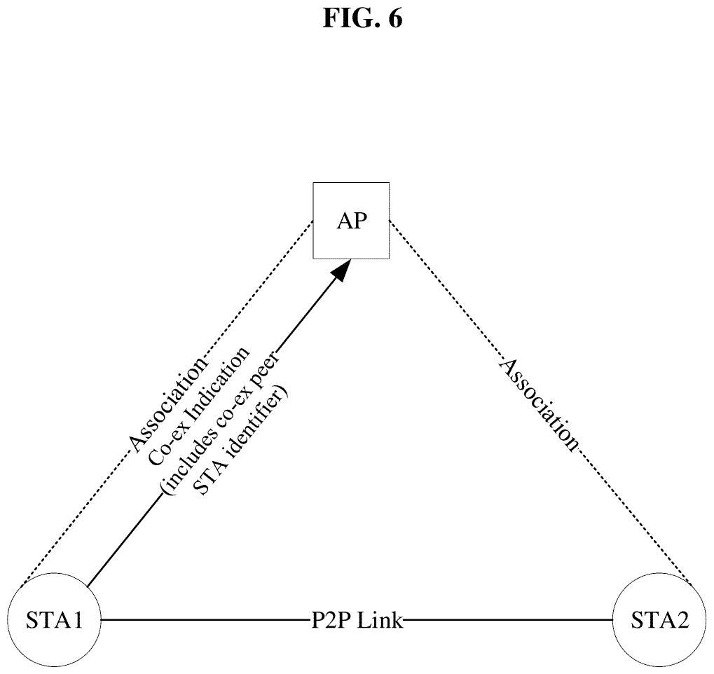

FIG. 6 shows another example indication of a coexistence event in accordance with an embodiment. The example depicted in FIG. 6 is for explanatory and illustration purposes. FIG. 6 does not limit the scope of this disclosure to any particular implementation.

Referring to FIG. 6, AP is associated with STA 1 and STA 2. STA 1 and STA 2 have a P2P link. STA 1 has an upcoming P2P communication with STA 2 as peer STAs, a coexistence event. STA 1 transmits, to AP, a frame including a coexistence indication (Co-ex indication). The coexistence indication includes identification information associated with STA 2 as a coexistence peer STA (co-ex peer STA identifier). The coexistence indication informs AP of the upcoming coexistence event so that AP knows that STA 1 and STA 2 are busy.

In an embodiment, a first STA may include, in a frame to an AP indicating a coexistence event, information associated with the coexistence event between the first STA and a second STA regarding the time instances or time duration for which the first STA has the upcoming coexistence event. The time instances or time duration may indicate a start time and an end time of the coexistence event.

In an embodiment, an AP may assume that a first STA and a second STA may be unavailable for a period of time when the AP receives a frame indicating a coexistence event from the first STA that includes information associated with the period of time. The period of time is a time duration or time instances for which the upcoming coexistence event is to occur within.

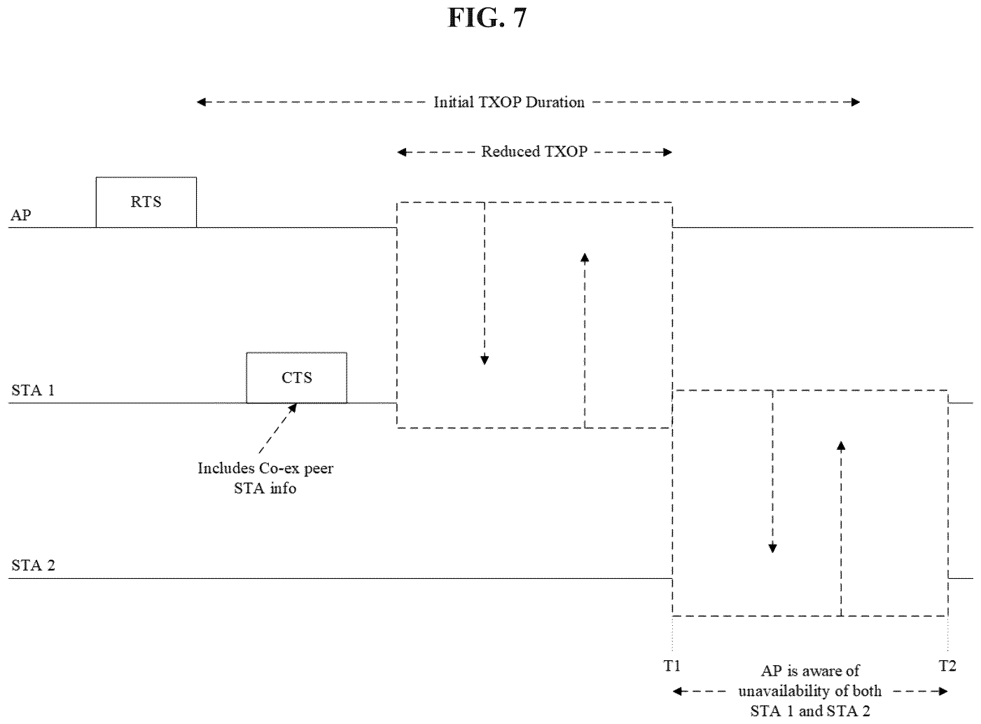

FIG. 7 shows another example indication of a coexistence event in accordance with an embodiment. The example depicted in FIG. 7 is for explanatory and illustration purposes. FIG. 7 does not limit the scope of this disclosure to any particular implementation.

Referring to FIG. 7, AP is associated with STA 1 and STA 2. STA 1 and STA 2 have a P2P link. STA 1 has an upcoming coexistence event with STA 2 based on STA 1 and STA 2 having P2P communication. AP transmits, to STA 1, an RTS indicating an initial TXOP duration. In response, STA 1 transmits, to AP, a CTS including coexistence peer STA information. The coexistence peer STA information indicates that STA 1 and STA 2 have P2P communication with one another and may be busy so AP knows that STA 1 and STA 2 are unavailable. Subsequently, AP and STA 1 perform communications with one another, for a reduced TXOP based on the indication of the coexistence event. At time T1 and after the reduced TXOP, STA 1 and STA 2 begin performing P2P communication with one another (Co-ex Peer Event). STA 1 and STA 2 finish their P2P communication at time T2. AP is aware of the unavailability of STA 1 and STA 2 for the duration of the coexistence peer event.

In an embodiment, an AP may not send any frame to either a first STA or a second STA during an indicated coexistence event period of time where the AP has received a frame from the first STA indicating a coexistence event that includes information of the period of time of the coexistence event and information about the second STA (a peer device).

In an embodiment, an AP may not expect to receive any frame (including an Acknowledgment frame and a Block Acknowledgement frame) from either a first STA or a second STA during an indicated coexistence event period of time where the AP has received a frame from the first STA indicating a coexistence event that includes information on the period of time of the coexistence event and information about the second STA (a peer device).

In an embodiment, a STA transmit, to an AP, a frame indicating a coexistence event including information about more than one second STAs that the first STA has to perform P2P communication with during the upcoming coexistence event. The AP may assume that the first STA and the second STAs may be busy and unavailable during the indicated coexistence event period of time based on the frame indicating the coexistence event.

In an embodiment, a STA can inform the AP about the coexistence events where the coexistence events are periodic in nature.

In an embodiment, a STA can inform an AP about a periodic coexistence (multiple coexistence events of a periodic nature) by transmitting a channel usage request frame to the AP. The channel usage request frame may contain a target-wake-time (TWT) element that can indicate the time periods during which the coexistence events are expected to occur.

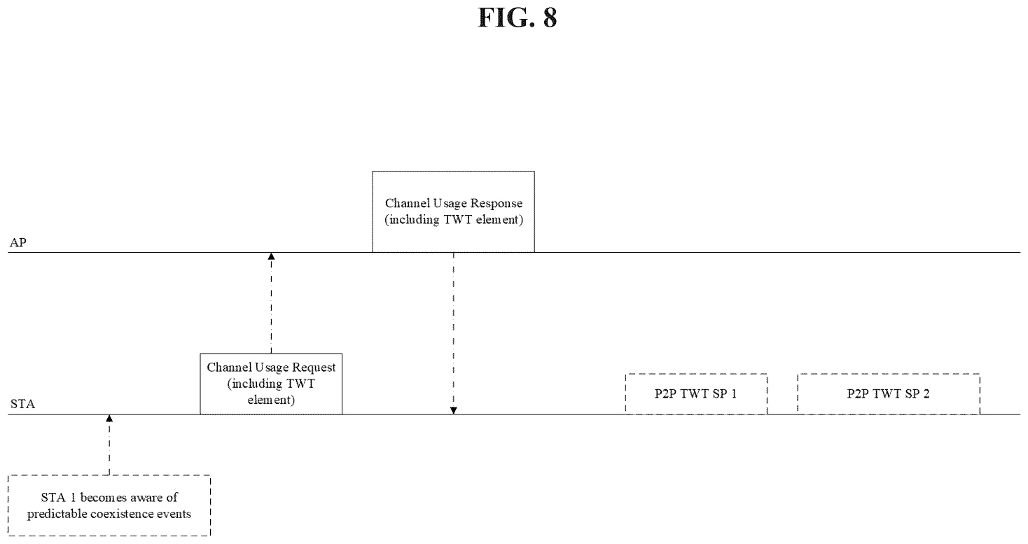

FIG. 8 shows an example management of a coexistence event in accordance with an embodiment. The example depicted in FIG. 8 is for explanatory and illustration purposes. FIG. 8 does not limit the scope of this disclosure to any particular implementation.

Referring to FIG. 8, AP is associated with STA 1. STA 1 has P2P communication with one or more second STAs for periods of time resulting in periodic coexistence. STA 1 transmits, to AP, a channel usage request frame including a TWT element. In response, AP transmits, to STA 1, a channel usage response frame including a TWT element. Subsequently, STA performs P2P communication during a P2P TWT SP 1. After a period of time, STA 1 performs P2P communication during a P2P TWT SP 2.

In an embodiment, an AP may receive a P2P TWT setup request from a STA. The AP may not transmit any frames to the STA during a P2P TWT SP which corresponds to a P2P TWT schedule if the AP accepts the P2P TWT setup request from the STA.

In an embodiment, an AP should end a frame transmission to a STA which it has accepted a P2P TWT setup request from if a P2P TWT SP is upcoming.

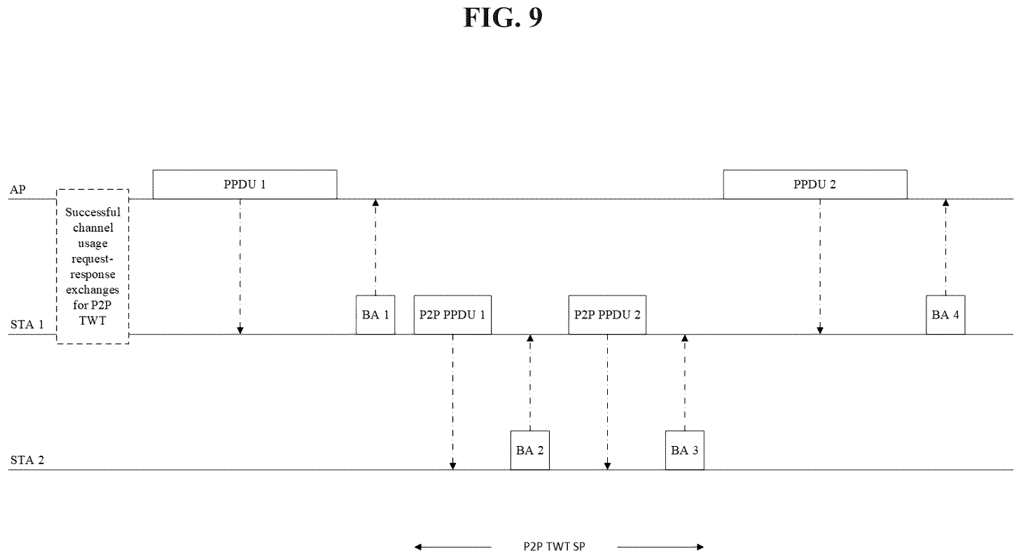

FIG. 9 shows an example management of a coexistence event in accordance with an embodiment. The example depicted in FIG. 9 is for explanatory and illustration purposes. FIG. 9 does not limit the scope of this disclosure to any particular implementation.

Referring to FIG. 9, AP is associated with STA 1 and STA 2. STA 1 has P2P communication with STA 2 during a P2P TWT SP. AP and STA have successfully exchanged a channel usage request frame and channel usage response frame to establish the P2P TWT SP. AP transmits, to STA 1, a frame (PPDU 1). In response STA 1 transmits, to AP, a block acknowledgement (BA) 1 frame. Subsequently, STA 1 transmits, to STA 2, a frame (P2P PPDU 1) during the P2P TWT SP. In response, STA 2 transmits, to STA 1, a BA 2 frame during the P2P TWT SP. Subsequently, STA 1 transmits, to STA 2, a frame (P2P PPDU 2) during the P2P TWT SP. In response, STA 2 transmits, to STA 1, a BA 3 frame during the P2P TWT SP. After the P2P TWT SP ends, AP transmits, to STA 1, a frame (PPDU 2). In response, STA 1 transmits, to AP, a BA 4 frame.

In an embodiment, a STA may, while setting up a P2P TWT SP, indicate how long the P2P TWT schedule will remain valid. For example, the STA can indicate that the schedule is valid for 10 SPs.

In an embodiment, a STA may modify parameters for a P2P TWT schedule after setting up the P2P TWT schedule. For example, the STA may use TWT Persistence parameters to modify the P2P TWT schedule.

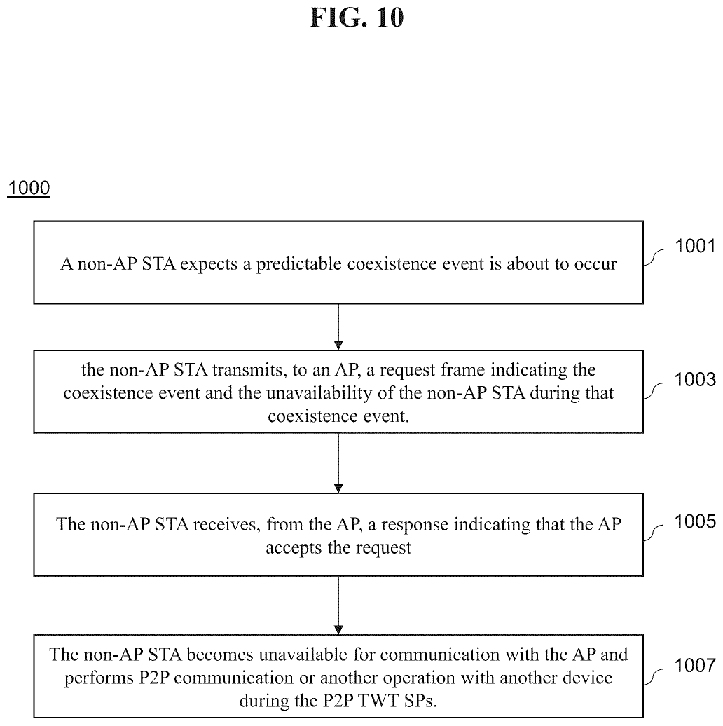

FIG. 10 shows an example process of managing a coexistence event in accordance with an embodiment. The example process depicted in FIG. 10 is for explanatory and illustration purposes. FIG. 10 does not limit the scope of this disclosure to any particular implementation.

Referring to FIG. 10, the process 1000 begins at operation 1001. In operation 1001, a non-AP STA expects a predictable coexistence event is about to occur.

In operation 1003, the non-AP STA transmits, to an AP, a request frame indicating the coexistence event and the unavailability of the non-AP STA during that coexistence event. The request frame may be a P2P TWT request frame.

In operation 1005, the non-AP STA receives, from the AP, a response indicating that the AP accepts the request. The response frame can be made by transmitting a P2P TWT response frame.

In operation 1007, The non-AP STA becomes unavailable for communication with the AP and performs P2P communication or another operation with another device during the P2P TWT SPs. The non-AP STA may perform operations with one or more other devices during the P2P TWT SPs.

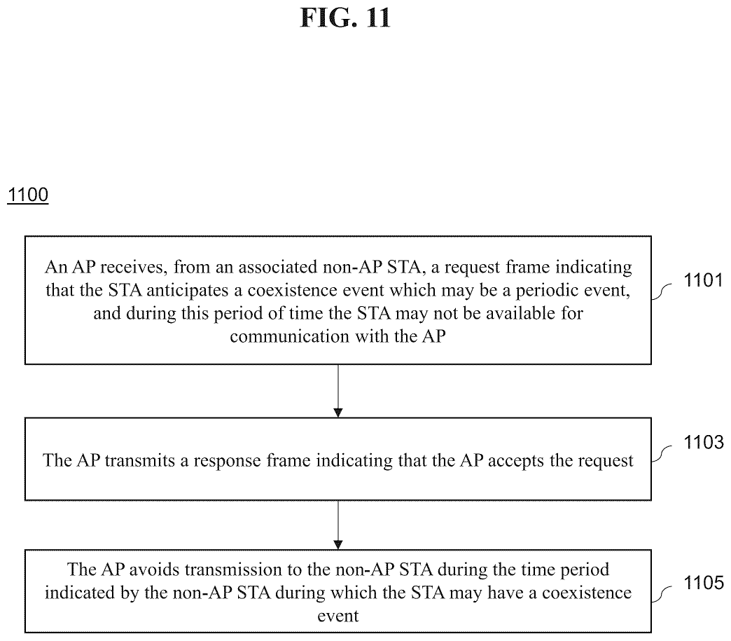

FIG. 11 shows another example process of managing a coexistence event in accordance with an embodiment. The example process depicted in FIG. 11 is for explanatory and illustration purposes. FIG. 11 does not limit the scope of this disclosure to any particular implementation.

Referring to FIG. 11, the process 1100 begins at operation 1101. In operation 1101, an AP receives, from an associated non-AP STA, a request frame indicating that the STA has an upcoming coexistence event which may be a periodic event, and during this period of time the STA may not be available for communication with the AP. The frame may be a channel usage request frame. The request frame may also indicate one or more peer STAs that may also not be available for communication with the AP due to the coexistence event.

In operation 1103, the AP transmits, to the non-AP STA, a response frame indicating that the AP accepts the request. The response frame may be a channel usage response frame.

In operation 1105, the AP avoids transmission to the non-AP STA during the time period indicated by the non-AP STA during which the STA may have a coexistence event.

This disclosure provides mechanisms and procedures for sharing information in a wireless network, such as a STA indicating to an AP a coexistence event involving the STA so that the AP knows the STA is busy and not to communicate with the STA during that period of time.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
transmitting, to an access point (AP), a frame indicating an upcoming coexistence event schedule; and
performing peer-to-peer communication with one or more peer STAs during the upcoming coexistence event schedule.

2. The STA of claim 1, wherein the frame indicates that the STA is unavailable for communication with the AP during the upcoming coexistence event schedule.

3. The STA of claim 1, wherein the processor is further configured to cause performing communication with the AP after transmitting the frame, wherein the communication with the AP ends before a start of the upcoming coexistence event schedule.

4. The STA of claim 1, wherein the frame includes a target wake time (TWT) element indicating one or more TWT service periods.

5. The STA of claim 4, wherein the frame includes information indicating a duration for which the upcoming coexistence schedule remains valid.

6. The STA of claim 1, wherein the frame includes information associated with the one or more peer STAs.

7. The STA of claim 6, wherein the frame indicates information associated with identities, characteristics, or capabilities of the one or more peer STAs.

8. The STA of claim 1, wherein:
the processor is further configured to cause:
receiving, from the AP, a control frame indicating a transmission opportunity (TXOP) duration; and
transmitting the frame in response to the control frame, wherein the frame indicates a period of time associated with the upcoming coexistence event schedule during which the STA is unavailable.

9. An access point (AP) in a wireless network, comprising:
a memory; and
a processor coupled to the memory, the processor configured to cause:
receiving, from a station (STA), a frame indicating an upcoming coexistence event schedule; and
abstaining from performing communication with the STA during the upcoming coexistence event schedule.

10. The AP of claim 9, wherein the frame indicates that the STA is unavailable for communication with the AP during the upcoming coexistence event schedule.

11. The AP of claim 9, wherein the processor is further configured to cause:
performing communication with the STA after receiving the frame; and
terminating the communication with the STA before a start of the upcoming coexistence event schedule.

12. The AP of claim 9, wherein the frame includes a target wake time (TWT) element indicating one or more TWT service periods.

13. The AP of claim 12, wherein the frame includes information indicating a duration of the upcoming coexistence schedule remains valid.

14. The AP of claim 9, wherein:
the frame includes information associated with one or more peer STAs, wherein the one or more peer STAs perform communications with the STA during the upcoming coexistence schedule; and
the processor is further configured to cause abstaining from performing communication with the one or more peer STAs during the upcoming coexistence event schedule.

15. The AP of claim 14, wherein the frame indicates information associated with identities, characteristics, or capabilities of the one or more peer STAs.

16. The AP of claim 9, wherein the processor is further configured to cause:
transmitting, to the STA, a control frame indicating a transmission opportunity (TXOP) duration; and
receiving the frame in response to the control frame, wherein the frame indicates a period of time associated with the upcoming coexistence event schedule during which the STA is unavailable.

17. A method performed by a station (STA), the method comprising:
transmitting, to an access point (AP), a frame indicating an upcoming coexistence event schedule; and
performing peer-to-peer communication with one or more peer STAs during the upcoming coexistence event schedule.

18. The method of claim 17, wherein the frame indicates that the STA is unavailable for communication with the AP during the upcoming coexistence event schedule.

19. The method of claim 17, wherein the method further comprises performing communication with the AP after transmitting the frame, wherein the communication with the AP ends before the start of the upcoming coexistence event schedule.

20. The method of claim 17, wherein the frame includes a target wake time (TWT) element indicating one or more TWT service periods.
